(19) United States
(12) Patent Application Publication
(10) Pub. No.: US 2025/0367703 A1
(43) Pub. Date: Dec. 4, 2025

(54) REINFORCEMENT AND REPAIR METHOD, REPAIR MATERIAL AND ABRASION DEPTH PREDICTION METHOD FOR DEBRIS FLOW PREVENTION STRUCTURE

(71) Applicant: Institute of Mountain Hazards and Environment, Chinese Academy of Sciences, Chengdu (CN)

(72) Inventors: Fan WU, Chengdu (CN); Jiangang CHEN, Chengdu (CN); Chenyuan WANG, Chengdu (CN); Jinhong HU, Chengdu (CN)

(21) Appl. No.: 19/302,587

(22) Filed: Aug. 18, 2025

(30) Foreign Application Priority Data
Apr. 8, 2025 (CN) 202510428586.X

(51) Int. Cl. B05D 5/00; E04G 23/02; G01B 21/18

(52) U.S. Cl. CPC B05D 5/005; E04G 23/02; G01B 21/18; B05D 2518/00

(57) ABSTRACT

A method for reinforcing and repairing a debris flow prevention structure is provided. A surface abrasion depth of the debris flow prevention structure is evaluated to formulate a reinforcement and repair strategy. During implementation of a repair project, a to-be-constructed area is cleaned according to the reinforcement and repair strategy, and a matrix enhancement material is poured into the to-be-constructed area so that the matrix enhancement material permeates into a substrate of the debris flow prevention structure for enhancing an ability to resist overall structural damage. A surface wear-resistant layer is arranged on a surface of the substrate to enhance an ability to resist surface damage. During construction, a plurality of polyurea blocks is fixed on the surface of the substrate in a bionic arrangement to form a bionic structure. A repair material and abrasion depth prediction method for the debris flow prevention structure are also provided.

### CROSS-REFERENCE TO RELATED APPLICATIONS

This application claims the benefit of priority from Chinese Patent Application No. 202510428586.X, filed on Apr. 8, 2025. The content of the aforementioned application, including any intervening amendments made thereto, is incorporated herein by reference in its entirety.

### TECHNICAL FIELD

This application relates to disaster prevention and mitigation, and more particularly to a reinforcement and repair method, repair material and abrasion depth prediction method for a debris flow prevention structure.

### BACKGROUND

Debris flow is a highly destructive natural disaster characterized by high velocity, high impact force and complex multiphase flow.

The main forms of damage caused by debris flows to prevention structures such as sand dams and drainage channels can be divided into overall structural damage and surface damage. Overall structural damage is commonly caused by the impact of debris flows and environmental factors that damage the substrate of the prevention structure. Under the coupling effect of debris flows and the environment (freeze-thaw environment, groundwater chemical erosion, etc.), the deterioration of the mortar matrix, fiber breakage, and aggregate peeling will all lead to a decrease in the overall strength of the prevention structure. Surface damage is commonly caused by the abrasion and erosion of the surface of the prevention structure by solid particles in the debris flow. During the movement of debris flows, the high-hardness particles carried therewith can abrade the surface of prevention structures or form erosion pits, reducing the protective effect of the substrate. Therefore, damage or destruction caused by debris flows shortens the service life of prevention structures, necessitating regular maintenance or repair.

In the prior art, Chinese Patent No. 114541337A disclosed a method for repairing a damaged section of a debris flow drainage channel, in which damaged areas of the drainage channel was identified, then the aged and deteriorated concrete layer was chiseled off, roughened, and cleaned to form a joint surface; the exposed steel bar on the joint surface was then rust-proofed and treated, dust and loose aggregate were removed; a wire rope mesh was laid on the joint surface; and the joint surface was then repaired with steel fiber reinforced concrete. This method quickly repairs the drainage channel and restores its drainage function. However, prior art typically relies on experience or surface observation to determine the damaged areas of the drainage channel, resulting in a relatively crude repair approach.

Therefore, those skilled in the art are seeking a more optimized solution for repairing debris flow prevention structures that can more precisely address both overall structural damage and surface damage, thereby improving construction quality.

### SUMMARY

In order to address the deficiency of sophistication in existing debris flow prevention structure repair solutions, the present disclosure provides a reinforcement and repair method, repair material and abrasion depth prediction method for a debris flow prevention structure, which can formulate reinforcement and repair strategies for the debris flow prevention structure based on abrasion depth, so that both overall structural damage and surface damage can be simultaneously repaired, thereby restoring or enhancing the strength, impact resistance, and wear resistance of the debris flow prevention structure.

Firstly, the disclosure utilizes abrasion depth as a key indicator for evaluating material wear resistance, estimating the extent of abrasion in debris flow prevention structures and formulating reinforcement and repair strategies. Based on this technical concept, this application provides a reinforcement and repair method, repair material and abrasion depth prediction method for a debris flow prevention structure.

Secondly, based on the concept of “both internal and external improvements”, the present disclosure uses a composite repair material to achieve the dual effects of overall damage control and surface abrasion prevention, comprehensively enhancing the strength, impact resistance, and wear resistance of the debris flow prevention structure.

Technical solutions of the present disclosure are described as follows.

In a first aspect, this application provides a method for reinforcing and repairing a debris flow prevention structure, comprising:
(1) evaluating a surface abrasion depth of the debris flow prevention structure to formulate a reinforcement and repair strategy;
(2) during implementation of a repair project, cleaning a to-be-constructed area according to the reinforcement and repair strategy, and pouring a matrix enhancement material into the to-be-constructed area so that the matrix enhancement material permeates into a substrate of the debris flow prevention structure for repairing or enhancing an ability to resist overall structural damage; and
(3) arranging a surface wear-resistant layer on a surface of the substrate to repair or enhance an ability to resist surface damage.

In some embodiments, the surface wear-resistant layer is made of hard iron sheet. During the construction process, the hard iron sheet is adhered to the surface of the substrate.

In some embodiments, the surface wear-resistant layer is formed by curing a polyurea material. During construction, the polyurea material is sprayed onto the surface of the substrate, or the plurality of polyurea blocks are fixed on the surface of the substrate in a bionic arrangement to form the bionic structure. Spraying the polyurea material onto the surface of the substrate is equivalent to complete coverage, and applying the bionic structure to the surface of the substrate for surface structuring treatment is equivalent to partial coverage.

In some embodiments, the bionic structure is a convex platform structure; the convex platform structure is composed of a plurality of convex strips that are raised relative to a surface profile of the substrate and arranged in parallel, and a length direction of the plurality of convex strips is perpendicular to a flow direction of a debris flow; and the plurality of convex strips are the plurality of polyurea blocks formed by means of compression molding.

In some embodiments, the bionic structure is a linear groove structure; the linear groove structure is composed of a plurality of strip-shaped grooves that are recessed relative to the surface profile of the substrate and arranged in parallel, and a length direction of the plurality of strip-shaped grooves is perpendicular to the flow direction of the debris flow; and the plurality of strip-shaped grooves are the plurality of polyurea blocks formed by means of compression molding.

In some embodiments, the bionic structure is a spherical groove structure; the spherical groove structure is formed by a plurality of hemispherical bodies that are recessed relative to the surface profile of the substrate and arranged in a matrix pattern; and the plurality of hemispherical bodies are the plurality of polyurea blocks formed by means of compression molding.

In some embodiments, the bionic structure is a grid groove structure; the grid groove structure is formed by a plurality of square blocks that are recessed relative to the surface profile of the substrate and arranged in a matrix pattern; and the plurality of square blocks are the plurality of polyurea blocks formed by means of compression molding.

In some embodiments, when using any one of the convex platform structure, the linear groove structure, the spherical groove structure or the grid groove structure, the method further comprising:

reserving a recess structure on the surface of the substrate according to a structure and arrangement of the plurality of polyurea blocks, and embedding the plurality of polyurea blocks in the recess structure.

In some embodiments, the matrix enhancement material comprises a coarse aggregate and a mortar; a gradation distribution of the coarse aggregate conforms to an Andreasen & Andersen model with a value of a distribution modulus q of 0.19; and the mortar is composed of a P·I-type 42.5-grade silicate cement, a microsilica fume, a sand, a steel fiber, a water reducing agent and water. The steel fiber is a copper-plated steel fiber, a hooked-end steel fiber, a milled steel fiber or a combination thereof.

In some embodiments, the steel fiber is a copper-plated steel fiber or a hooked-end steel fiber, and a dosage of the steel fiber is 1% of a total volume of the matrix enhancement material.

In a second aspect, this application provides a repair material for a debris flow prevention structure, comprising:
a matrix enhancement material; and
a surface wear-resistant layer;
wherein the matrix enhancement material is permeatable into a substrate of the debris flow prevention structure, and is configured to enhance resistance and reduce an overall structural damage caused by debris flow impact and environmental factors; and
the surface wear-resistant layer is capable of covering a surface of the debris flow prevention structure, and is configured to enhance resistance and reduce a surface damage caused by particle scouring in a debris flow.

In some embodiments, the present disclosure adopts concrete primarily composed of coarse aggregate and mortar as the matrix enhancement material. The particle size of the particulate matter in the matrix enhancement material is relatively small, enabling it to permeate into the substrate of the debris flow prevention structure. The overall impact resistance is enhanced through mortar matrix strengthening and fiber reinforcement treatment.

In order to improve the impact and abrasion resistance of the repaired debris flow prevention structure, the coarse aggregate and mortar in the matrix enhancement material required to be designed.

The gradation distribution of the coarse aggregate conforms to the Andreasen & Andersen model, with a distribution modulus q value of 0.19. The common raw material for coarse aggregate is limestone crushed stone. The content of coarse aggregate per cubic meter of matrix enhancement material is 650-670 kg.

A gradation curve of the coarse aggregate is calculated through Equations (1), (2) and (3):

$$P ( D ) = \frac{{D}^{q} - {D}_{min}^{q}}{{D}_{max}^{q} - {D}_{min}^{q}} \qquad ( 1 )$$

$$RSS = {\sum }_{i = 1}^{n} {[ {P}_{mix} ( {D}_{i}^{i + 1} ) - {P}_{tar} ( {D}_{l}^{i + 1} ) ]}^{2} \to min \qquad ( 2 )$$

$${R}^{2} = 1 - \frac{{{\sum }_{i = 1}^{n} [ {P}_{mix} ( {D}_{i}^{i + 1} ) - {P}_{tar} ( {D}_{i}^{i + 1} ) ]}^{2}}{{{\sum }_{i = 1}^{n} [ {P}_{mix} ( {D}_{i}^{i + 1} ) - \frac{1}{n} {\sum }_{i = 1}^{n} {P}_{mix} ( {D}_{i}^{i + 1} ) ]}^{2}} \qquad ( 3 )$$

In the Equations (1), (2) and (3), P (D) represents a cumulative fraction of total solids with particle size less than D; all D-related parameters are particle size-related parameters, unit: mm; the superscript q of D^{q}, Dₘᵢₙ^{q} and Dₘₐₓ^{q} is a distribution modulus controlling a shape of the gradation curve, where a smaller value of q indicates a higher proportion of fine aggregate, herein set to 0.19; D^{q} represents a particle size of the aggregate corresponding to distribution modulus q; Dₘᵢₙ^{q} represents the minimum particle size of the aggregate corresponding to distribution modulus q; Dₘₐₓ^{q} represents the maximum particle size of the aggregate corresponding to distribution modulus q; RRS represents a residual sum of squares indicating a difference between an actual gradation and a target gradation; n represents a total number of particle size intervals; i represents an index number of the particle size intervals; Dᵢⁱ⁺¹ represents segmentation of the particle size intervals;

$${P}_{mix} ( {D}_{i}^{i + 1} )$$

represents a cumulative percentage of the designed gradation mixture in a particle size interval [Dᵢ, Dᵢ₊₁];

$${P}_{tar} ( {D}_{i}^{i + 1} )$$

represents a cumulative percentage of the target gradation mixture in the same particle size interval [Dᵢ, Dᵢ₊₁], taken as the result calculated by the Equation (1); and R² represents a coefficient of determination ranging [0, 1], which is used to evaluate the goodness of fit between the designed gradation distribution and the target gradation distribution, a value closer to 1 indicates better fit, while a value closer to 0 indicates poorer fit.

The Equation (2) is used to optimize the fit between the designed gradation curve and the target gradation curve using the least squares method. The Equation (3) quantifies the degree of matching through the coefficient of determination R².

The mortar is composed of P·I-type 42.5-grade silicate cement, a microsilica fume, a sand, a steel fiber, a water reducing agent and water.

Silicate cement in the mortar serves as a primary binding material for bonding other components together and providing the basis for early and late strength. The 42.5 strength grade indicates a 28-day compressive strength ≥42.5 MPa. With a specific surface area of 3550 cm²/g and a density of 3.12 g/cm³, the silicate cement is a key source of the mortar's mechanical properties.

The sand serves as a fine aggregate, which can assist the coarse aggregate in building a rigid skeleton to reduce cracks generated during cement hydration or drying, and disperse loads to indirectly improve material toughness.

Microsilica fume has an extremely fine particle size, typically 0.1-0.2 μm, which can fill inter-particle voids to improve compactness, and is used to refine a microstructure of concrete. Pozzolanic reactions of microsilica fume in the mortar generate additional gel, so that a bonding performance between steel fibers and the substrate is synergistically enhanced with cement, resulting in enhanced late-age strength and durability. Generally used microsilica fume has a SiO₂ content of 92.3% and a specific surface area of 19.1 m²/g.

The steel fiber delays crack propagation through crack bridging, so that the tensile strength, impact resistance, and toughness of the mortar are increased, providing crack resistance and toughening effects. After incorporating the steel fiber into the substrate, brittle fracture is transformed into ductile failure, thereby enhancing structural safety by altering the failure mode. Typically, the steel fiber is one or more of a copper-plated steel fiber, a hooked-end steel fiber and a milled steel fiber.

The water reducing agent is used to reduce a water-to-binder ratio and mitigate fluidity loss issues caused by high microsilica fume dosage. A polycarboxylate-based water reducing agent is generally used, with a solid content of 50% and a dosage of 0.5% to 1.5% of a weight of the binding material.

Therefore, the cement, microsilica fume, steel fiber, sand and water reducing agent form a synergistic effect.

In some embodiments, the surface wear-resistant material employs polyurea coating or iron sheet.

Firstly, particle cutting, micro-cracks, scratches, and indentations are the main causes of damage to the surface concrete of debris flow prevention structures. Through research and testing, it has been found that applying polyurea coating, polyurethane waterproof coating, iron sheet, or rubber to the surface of debris flow prevention structures can improve the abrasion resistance, erosion resistance, and flexural strength of concrete. Among these, the wear rates of concrete treated with polyurea coating and iron sheet within 48 h are 0.04 g/h and 0.03 g/h, respectively. Compared to untreated concrete, reductions of 75% and 81% are achieved, respectively. Superior impact and scratch resistance are demonstrated, making them preferred solutions.

Therefore, during surface treatment of debris flow prevention structures, polyurea material may be sprayed onto the surface to form a polyurea layer. In some embodiments, a rigid iron sheet layer may be selected as the surface wear-resistant layer based on actual conditions. During construction, the rigid iron sheet is bonded to the surface of the prevention structure.

A polyurea layer thickness DPUA and an average debris flow particle size D4 satisfy Equation (4):

$${D}_{PUA} \leq {D}_{4} / 5.4 \qquad ( 4 )$$

An iron sheet thickness Dis and the average debris flow particle size D4 satisfy Equation (5):

$${D}_{IS} \leq {D}_{4} / 33.2 \qquad ( 5 )$$

During construction, the polyurea layer thickness may be designed with reference to the Equation (4), and the iron sheet layer thickness may be designed with reference to the Equation (5).

Compared to the polyurea layer formed using polyurea material, iron sheet is a rigid layer with higher compressive strength, lower cost, and relatively easy bonding construction, but it also has disadvantages. The adhesion between iron sheet and the substrate is relatively weak, which makes loosening or detachment prone to occur, and leads to a shorter service life per application. Iron sheet is difficult to adapt to complex curved or irregular surfaces, requiring cutting and splicing during construction. Iron sheet is susceptible to rusting in humid or corrosive environments, necessitating regular maintenance. The density of iron sheet is relatively high, increasing the dead load of the prevention structure. In contrast to rigid iron sheet, polyurea coating is a flexible coating with high raw material cost, and professional equipment and technical personnel are required for its application. However, polyurea material possesses excellent physical and chemical properties such as high strength, high elongation, high wear resistance, and high aging resistance. Moreover, polyurea material cures rapidly, which can be sprayed to form on any curved, sloped, or vertical surface without sagging. The coating is continuous, dense, and seamless, resulting in outstanding protective performance. During actual construction, selection may be made by personnel based on construction requirements and conditions.

Although polyurea coating offers superior comprehensive prevention compared to iron sheet, the method of overall coating on the surface of debris flow prevention structures requires a large amount of polyurea material, resulting in high cost.

In order to minimize the usage of polyurea material while enhancing the impact and wear resistance of the debris flow prevention structure surface, a scheme for surface structuring of the polyurea layer is proposed in the present disclosure. Bionically arranged polyurea blocks are used to replace the polyurea layer. Compared to a polyurea layer fully covering the substrate surface, polyurea blocks partially covering the substrate surface ensure abrasion resistance while effectively reducing polyurea material consumption.

Specifically, before the polyurea material is completely cured, four types of polyurea blocks, including a convex strip-type polyurea block, a strip-shaped groove-type polyurea block, a hemispherical body-type polyurea block and a square-type polyurea block, are formed by means of compression molding. Multiple polyurea blocks are arranged bionically on the substrate surface, forming corresponding convex platform structure, linear groove structure, spherical groove structure and grid groove structure. The convex strip-type polyurea block protrude relative to the substrate surface profile.

The strip-shaped groove-type polyurea block, the hemispherical body-type polyurea block and the square-type polyurea block are recessed relative to the substrate surface profile. The convex platform structure is composed of multiple elongated convex strips arranged in parallel. The linear groove structure is composed of multiple strip-shaped grooves arranged in parallel. Both the convex platform structure and the linear groove structure belong to stripe structures, differing only in being convex or concave relative to the substrate surface.

Typically, ignoring the effects of machining and construction accuracy, the height of the convex strip is equated to its protrusion height above the substrate surface profile. The height of the strip-shaped groove is equated to its recessed depth into the substrate surface profile. The circular base height of the hemispherical body is equated to its recessed depth into the substrate surface profile. The height of the square block is equated to the recessed depth of the strip-shaped groove into the substrate surface profile. In should be noted that for a standard hemispherical body, the circular base height equals its radius. Although machining a standard hemispherical body is difficult in practice, the radius is still used as the circular base height for parameter calculation. During installation, the circular plane of the hemispherical body is flush with the substrate surface profile. Multiple hemispherical bodies are typically distributed at equal row and column spacings. It should be noted that the length and width of convex strips and strip-shaped grooves are relatively large. Typically, the convex strips and strip-shaped grooves have a length that equals the width of the debris flow prevention structure, and are distributed at equal spacings. It should be noted that the aspect ratio of square blocks is 1. Multiple square blocks are typically distributed at equal row and column spacings.

In order to facilitate description of the structure and distribution of polyurea blocks, the height of the convex strip, height of the strip-shaped groove, circular base height of the hemispherical body, and height of the square block are recorded as the block height D₁. The distance between adjacent convex strips, adjacent strip-shaped grooves, adjacent hemispherical bodies, and adjacent square blocks is recorded as the block spacing D₂. The width of the convex strip, width of the strip-shaped groove, diameter of the circular surface of the hemispherical body, and width of the square block are recorded as the block width D₃.

The block height D₁, block spacing D₂, block width D₃ and average debris flow particle size D₄ satisfy Equations (6), (7) and (8):

$${D}_{1} \geq {D}_{4} / 1.2 \qquad ( 6 )$$

$${D}_{2} \leq 2 {D}_{3} \qquad ( 7 )$$

$${D}_{2} \geq {D}_{4} \qquad ( 8 )$$

The arranged convex strips or grooves in the bionic structure are oriented perpendicular to the debris flow direction. It should be noted that the debris flow direction is a macroscopic description of the overall flow direction, not an absolute orientation. Herein, the perpendicular relationship is also generalized, not strictly 90°; typically, deviations within 10° are considered perpendicular. Furthermore, the local flow direction at specific positions traversed by debris flow may deviate significantly from the overall direction. Therefore, during actual construction, the length direction of the stripe structures such as convex strips or grooves is not aligned with the debris flow direction but perpendicular to the debris flow direction.

In a third aspect, this application provides a method for predicting an abrasion depth of a debris flow prevention structure that is adapted to implement the above method for reinforcing and repairing the debris flow prevention structure, comprising:
estimating the abrasion depth according to a structural density of the debris flow prevention structure, a duration of the debris flow, an abrasion coefficient and a correction coefficient.

In some embodiments, the value of the correction coefficient is obtained by calculation according to two sets of parameters related to the volume content, density, particle size, and flow velocity of the solid-phase particles in the debris flow parameters and the laboratory test parameters.

It should be noted that the repairing method and repairing material provided by the disclosure are not only applicable to repairing damaged areas of debris flow prevention structures but also applicable to enhancing the protective performance of such structures and utilizable for both post-disaster restoration and pre-disaster prevention. Furthermore, the repairing method and repairing material provided by the disclosure are employed not only to repair or enhance the overall strength of debris flow prevention structures but also to comprehensively reinforce and improve the performance of prevention structures through surface characteristic enhancement treatments, thereby achieving integrated overall damage control and surface abrasion prevention.

Additionally, it should be noted that the abrasion depth prediction method of the present disclosure is primarily used to predict the abrasion depth formed by debris flow scouring on materials. The predicted abrasion depth is utilizable for determining repair timing, identifying areas to be constructed, and selecting parameters of repair materials, thereby formulating a reinforcement and repair strategy.

Consequently, the abrasion depth is first rapidly assessed on-site using the abrasion depth prediction method provided herein. Combined with integrated damage control and surface abrasion prevention technology, repair or enhancement of the impact resistance and abrasion resistance of debris flow prevention structures is achieved. The method can be widely applicable to debris flow prevention structures such as check dams and drainage channels, as well as other hydraulic and transportation infrastructure projects requiring impact resistance and abrasion resistance. Technical support is thereby provided for strengthening and reinforcing mountain disaster prevention engineering.

Compared to the prior art, the present disclosure has the following beneficial effects.

(1) The method for reinforcing and repairing the debris flow prevention structure provided in the present disclosure utilizes abrasion depth as a key indicator for evaluating material wear resistance. A reinforcement and repair strategy for debris flow prevention structures is formulated based on the abrasion depth, thereby obtaining a more precise and economical repair solution.

(2) By virtue of the composite repair material, an internal-external composite repair mechanism is implemented on debris flow prevention structure, so that dual effects of integrated damage control and surface abrasion prevention are achieved, and the strength, impact resistance, and wear resistance of debris flow prevention structure are comprehensively enhanced.

(3) The impact resistance and abrasion resistance of debris flow prevention structure are significantly enhanced by the method provided herein, thereby providing technical support for strengthening and reinforcing mountain disaster prevention engineering.

(4) The material for reinforcing, and repairing debris flow prevention structures provided by the present disclosure is primarily composed of a matrix enhancement material and a surface wear-resistant material. The matrix enhancement material is capable of permeating into the substrate of the prevention structure to enhance overall strength and improve impact resistance. A surface wear-resistant layer is formable on the surface to enhance abrasion resistance and erosion resistance.

(5) The abrasion depth prediction method for the debris flow prevention structure provided by the present disclosure enables precise estimation of abrasion depth., so as to provide critical reference for formulating reinforcement and repair strategies for debris flow prevention structures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a method for reinforcing and repairing a debris flow prevention structure in accordance with an embodiment of the present disclosure;

FIG. 2 shows a fitted abrasion coefficient curve in accordance with an embodiment of the present disclosure;

FIG. 3 shows abrasion rates of samples Ref.1, S1, M1, L1, M0.5 and M1.5 in accordance with an embodiment of the present disclosure;

FIG. 4 shows abrasion depths of the samples Ref.1, S1, M1, L1, M0.5 and M1.5;

FIGS. 5a-e are schematic diagrams of various types of surface wear-resistant layers for the debris flow prevention structure in accordance with an embodiment of the present disclosure, where FIG. 5a refers to sample Ref.2, FIG. 5b refers to sample PUA, FIG. 5c refers to sample PUR, FIG. 5d refers to sample IS, and FIG. 5e refers to sample RB;

FIG. 6 shows abrasion time and abrasion rate of four sample groups Ref.2, PUA, IS, and RB in accordance with an embodiment of the present disclosure;

FIG. 7 shows abrasion time and abrasion rate of a sample PUR in accordance with an embodiment of the present disclosure;

FIGS. 8a-b are structural diagrams of a sample Convex, where FIG. 8a is a top view of a bionic structure of Convex, and FIG. 8b is a side view of the bionic structure of Convex;

FIGS. 9a-b are structural diagrams of a sample Parallel, where FIG. 9a is a top view of a bionic structure of Parallel, and FIG. 9b is a side view of the bionic structure of Parallel;

FIGS. 10a-b are structural diagrams of a sample Circle, where FIG. 10a is a top view of a bionic structure of Circle, and FIG. 10b is a side view of the bionic structure of Circle;

FIGS. 11a-b are structural diagrams of a sample Net, where FIG. 11a is a top view of a bionic structure of Net, and FIG. 11b is a side view of the bionic structure of Net;

FIG. 12 shows weight loss after 24 h of abrasion for samples Ref. 3, Convex, Parallel, Circle and Net;

FIGS. 13a-b show compressive strength and flexural strength test results after 24 h of abrasion for the samples Convex, Parallel, Circle and Net, where FIG. 13a refers to the compressive strength test results, and FIG. 13b refers to the flexural strength test results;

FIG. 14 shows weight loss after 24 h of abrasion for samples Parallel and Convex when a block width and a block spacing are designed as 4 mm, 6 mm, and 8 mm;

FIGS. 15a-b show compressive strength and flexural strength test results after 24 h of abrasion for samples Parallel and Convex when the block width and block spacing are designed as 4 mm, 6 mm, and 8 mm, where FIG. 15a refers to the compressive strength test results, and FIG. 15b refers to the flexural strength test results;

FIGS. 16a-e illustrate surface abrasion conditions of the samples Ref.3, Convex, Parallel, Circle and Net whose surfaces are eroded by solid particles in a debris flow, where FIG. 16a illustrates the surface abrasion condition of sample Ref.3, FIG. 16b illustrates the surface abrasion condition of sample Convex, FIG. 16c illustrates the surface abrasion condition of sample Parallel, FIG. 16d illustrates the surface abrasion condition of sample Circle, and FIG. 16e illustrates the surface abrasion condition of sample Net; and

FIGS. 17a-e illustrate surface morphology of the samples Ref.3, Convex, Parallel, Circle and Net after 24 h of abrasion, where FIG. 17a illustrates a surface abrasion morphology of sample Ref.3, FIG. 17b illustrates a surface abrasion morphology of sample Convex, FIG. 17c illustrates a surface abrasion morphology of sample Parallel, FIG. 17d illustrates a surface abrasion morphology of sample Circle, and FIG. 17e illustrates a surface abrasion morphology of sample Net.

In the drawings: 1. abrasion-damaged surface; 2. impact-damaged substrate; 3. surface wear-resistant material; 3.1. flat-laid surface wear-resistant layer; 3.2. bionic structure; 4. matrix enhancement material; 4.1. fiber reinforcement; and 4.2. particle-packing-model-conforming aggregate.

### DETAILED DESCRIPTION OF EMBODIMENTS

The present disclosure will be further described in detail below in conjunction with the embodiments. However, it should not be understood that the following embodiments are not intended to limit the scope of the application. Any substitutions and modifications made by those of ordinary skill in the art without departing from the spirit of the disclosure shall fall within the scope of the disclosure defined by the appended claims.

### Embodiment 1

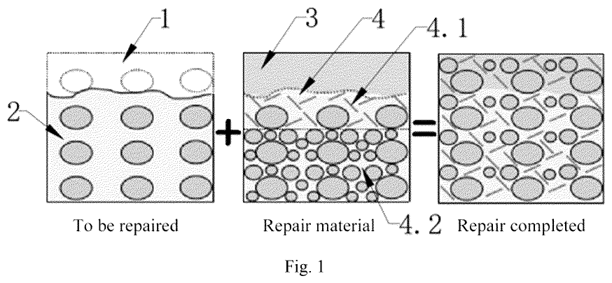

As shown in FIG. 1, a debris flow prevention structure has suffered severe damage due to debris flow disasters, and an abrasion-damaged surface 1 and an impact-damaged substrate 2 need to be repaired. This embodiment proposes a method for reinforcing and repairing the debris flow prevention structure. An abrasion depth on a surface of the prevention structure is assessed to formulate a reinforcement and repair strategy, and then repair materials are used for construction. According to the reinforcement and repair strategy, during the implementation of the repair project, a to-be-constructed area is cleaned. A matrix enhancement material 4 is then poured into the to-be-constructed area, so that the matrix enhancement material 4 permeates into a substrate of the prevention structure. The matrix enhancement material 4 permeates into the substrate of the debris flow prevention structure, which adopts a steel fiber as a fiber reinforcement 4.1 and coarse and fine aggregates to form a particle-packing-model-conforming aggregate 4.2 for repairing or enhancing the structure's ability to resist overall structural damage. Subsequently, a surface wear-resistant material 3 is applied to the surface of the prevention structure to form a surface wear-resistant layer, which is used to repair or enhance the ability to resist surface damage.

The method commonly includes the following construction steps.

### (S1) Construction Preparation

The surface of the debris flow prevention structure is cleaned, and a loose material and debris are removed. The to-be-constructed area is measured and marked according to a design drawing.

### (S2) Construction of Matrix Enhancement Material 4

The matrix enhancement material 4 is prepared according to a design mix ratio. The matrix enhancement material 4 is thoroughly mixed and poured into the to-be-constructed area. Bubbles are eliminated using a vibrating device to ensure matrix densification. Curing is performed under ambient temperature for 28 days.

### (S3) Construction of Surface Wear-Resistant Material 3

After substrate curing is completed, a polyurea material is sprayed or a hard iron skin layer is bonded. If a bionic treatment is designed, polyurea blocks are processed by means of compression molding and fixed onto the concrete substrate surface to form a bionic arrangement.

### (S4) Construction Acceptance and Later Maintenance

A uniformity of the surface wear-resistant layer and an integrity of the bionic structure 3.2 are inspected using a three-dimensional (3D) scanner. A wear condition of the surface wear-resistant layer is inspected periodically, and supplementary spraying or repair is performed as necessary.

The reinforcement and repair strategy provided herein includes, but is not limited to, determining the repair timing, identifying the to-be-constructed area, and selecting parameters for the repair material.

Firstly, the abrasion depth can qualitatively reflect the degree of impact by debris flow disasters in a specific area and the importance of requiring protective repair. If the abrasion depth has exceeded an alert threshold, emergency protective repair work is required to be carried out as soon as possible. If the abrasion depth has not exceeded but is close to the alert threshold, preventive protective repair work is required to be planned for the short term. If the abrasion depth is within the alert threshold range and is significantly less than the alert threshold, routine maintenance may be performed during the low-incidence period of debris flow disasters. During the high-incidence period of debris flow disasters, the inspection frequency is increased, and preventive protective repair work is carried out based on warning conditions. The above scenarios for determining repair timing are general guidelines only. The repair timing may also be determined by personnel based on actual conditions.

Secondly, the structural density and structural abrasion coefficient of different areas of a debris flow prevention structure are not necessarily identical. When debris flows pass through different areas, debris flow parameters such as the volumetric content, density, particle size, flow velocity, and duration of solid particles are not necessarily identical. Consequently, the abrasion depth typically varies across different areas. Therefore, to conserve resources for economic benefit, areas that have already suffered severe abrasion or are predicted to suffer severe abrasion are usually designated as the to-be-constructed areas for repair during post-disaster restoration or pre-disaster prevention. Thus, the to-be-constructed areas can be identified by personnel based on abrasion depth, resulting in a more scientific site selection method.

Thirdly, the specific material selection and mix ratio of various components in the repair material not only affect the abrasion coefficient of the repair material itself, but also affect the performance of the debris flow prevention structure after repair construction. Areas with greater abrasion depths often require repair materials with higher inherent abrasion coefficients, or repair materials capable of increasing the structural density after repair. Therefore, knowledge of the abrasion depth is advantageous for determining the specific substances of the components in the repair material and for determining the mix ratio of the components in the repair material.

Fourthly, knowledge of the overall abrasion depth in the to-be-constructed area provides a scientific basis for pre-construction planning tasks such as estimating workload and repair material quantities. This leads to more compact construction schedule and more standardized material usage, thereby improving the economic efficiency of the project.

In summary, based on a rapid on-site abrasion depth assessment method and in combination overall damage control and surface abrasion prevention technology, this embodiment achieves a significant enhancement in the impact resistance and abrasion resistance of the debris flow prevention structure, which can provide technical support for the strengthening and reinforcement of mountain disaster prevention engineering. The method of the disclosure can be widely applied to debris flow prevention structures such as check dams and drainage channels, as well as other hydraulic and transportation infrastructure projects requiring impact resistance and abrasion resistance.

### Embodiment 2

An abrasion depth prediction method for the debris flow prevention structure is provided herein.

Abrasion depth prediction is also referred to as abrasion depth assessment, and the abrasion depth assessment of the debris flow prevention structure is a key step in formulating a reinforcement and repair strategy. The abrasion depth prediction method of the present disclosure estimates the abrasion depth based on the structural density of the debris flow prevention structure, the duration of the debris flow, an abrasion coefficient, and a correction coefficient, and is used to implement the method in Embodiment 1.

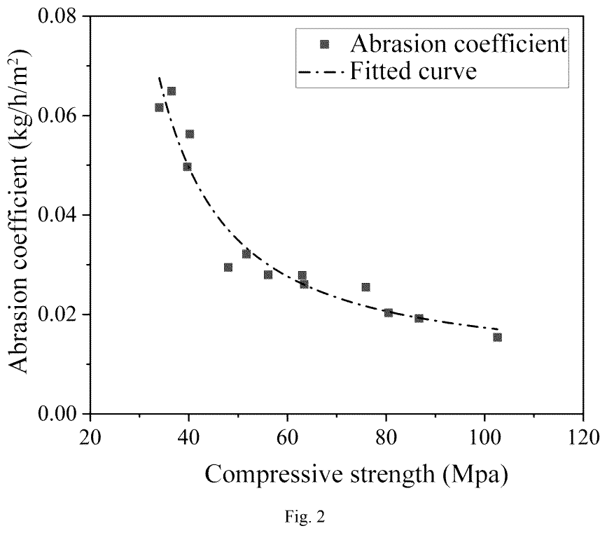

A sample is abraded using a wear resistance testing device disclosed in Chinese Patent No. CN113390745A. The parameters of the abrasive material used for testing include solid particle volume content V₀ of 30%, solid particle density P₀ of 2000 kg/m³, average solid particle diameter D₀ of 0.015 m, and velocity W₀ of 3 m/s. The compressive strength of the sample is then measured, and the relationship between compressive strength and the abrasion coefficient is fitted with the results shown in FIG. 2.

Furthermore, a method for rapidly estimating the abrasion coefficient is provided in this embodiment. Specifically, the abrasion coefficient is estimated through Equation (9) based on the compressive strength value:

$${log}_{10} k = \frac{30.43}{{f}_{c}} - 2.07 \qquad ( 9 )$$

In the Equation (9), k represents the abrasion coefficient, in kg/h/m², which us used to characterize the weight loss of material per unit time and per unit area; and fc represents the compressive strength, in MPa.

Furthermore, a method for rapidly calculating the correction coefficient is provided in this embodiment. The correction coefficient is calculated through Equation (10) based on two sets of parameters related to the volume content, density, particle size, and flow velocity of solid particles from the debris flow parameters and the laboratory test parameters:

$$a = ( \frac{{V}_{s}}{{V}_{0}} ) \times ( \frac{{ρ}_{s}}{{ρ}_{0}} ) \times {( \frac{{D}_{s}}{{D}_{0}} )}^{2} \times {( \frac{{u}_{s}}{{u}_{0}} )}^{2} \qquad ( 10 )$$

In the Equation (10), a represents the correction coefficient, which is used to adjust a difference between indoor abrasive parameters and actual debris flow parameters during abrasion coefficient testing; Vₛ, Pₛ, Dₛ and μₛ are debris flow parameters, representing a volume content (unit: %), density (unit: kg/m³), a particle size (unit: m), and a flow velocity (unit: m/s) of the solid phase particles of the debris flow, respectively; and V₀, ρ₀, D₀ and μ₀ are laboratory test parameters, representing a volume content (unit: %), a density (unit: kg/m³), a particle size (unit: m), and a flow velocity (unit: m/s) of the solid phase particles of the abrasive, respectively.

Finally, the abrasion depth is estimated according to Equation (11) in combination with the prevention structure density and the debris flow duration:

$${E}_{h} = \frac{a \times k \times t}{{ρ}_{c}} \qquad ( 11 )$$

In the Equation (11), En represents the abrasion depth, unit: m; k is an abrasion coefficient representing a abrasion weight loss per unit area per unit time, unit: kg/h/m²; Pc represents a structural density of the debris flow prevention structure, unit: kg/m³; t represents a duration of a debris flow, unit: h; and α represents the correction coefficient.

### Embodiment 3

A repair material used in the method of Embodiment 1 will be described in detail as follows.

The repair material includes a matrix enhancement material 4 and a surface wear-resistant material 3. The matrix enhancement material 4 is capable of permeating into the substrate of the prevention structure for repairing or enhancing resistance to overall structural damage. The surface wear-resistant material 3 is capable of covering the surface of the prevention structure for repairing or enhancing resistance to surface damage.

In an embodiment, a gradation distribution of coarse aggregate conforms to a modified Andreasen & Andersen model, with a distribution modulus q value of 0.19. Limestone crushed stone with a maximum particle size of 9.5 mm is used as the coarse aggregate. The mortar is composed of P·I-type 42.5-grade silicate cement, a microsilica fume, ISO standard sand, a steel fiber, a water reducing agent and water. The water reducing agent is a polycarboxylate-based high-performance water reducing agent with a solid content of 50 wt. %. Per cubic meter of the matrix enhancement material 4, the contents of coarse aggregate, silicate cement, microsilica fume, ISO standard sand, water reducing agent, and water are 661 kg, 450 kg, 50 kg, 640 kg, 5 kg, and 125 kg, respectively. The steel fiber is any one of a copper-plated steel fiber, a hooked-end steel fiber, or a milled steel fiber. A dosage of the steel fiber is 0.5%-1.5% of a total volume of the concrete.

In this embodiment, all samples are prepared with reference to a conventional concrete pouring method (GB/T 50080-2016), where demolding is performed after 24 h, and curing is then carried out in water at 20±2° C. until the testing age. Mechanical property testing, anti-abrasion performance testing, and microstructure and surface wear observation are performed on the samples.

During mechanical property testing, the compressive strength and flexural strength of 40×40×160 mm³ samples at a 28-day age are tested according to standard EN 196-1, with loading rates of 2400 N/s and 50 N/s, respectively. The splitting tensile strength of 100×100×100 mm³ samples at a 28-day age is tested according to standard EN 12390-6, with a loading rate of 0.05 MPa/s. An average value of three parallel samples is recorded as the test result. During anti-abrasion performance testing, the samples are abraded using a wear resistance testing device disclosed in Chinese Patent No. CN113390745A. Wear morphology observation is performed on samples after 24 h, 48 h, 72 h and 96 h of abrasion. The wear amount is obtained by weighing. The wear depth is obtained by fixed-point measurement, for assessing wear performance. Due to differences in wear morphology, it is difficult to determine the wear height at every point on the sample surface. Therefore, three fixed points along the length direction of the sample surface: 40 mm, 80 mm, and 120 mm, are selected as measurement points for wear depth measurement. Measurement is performed using a vernier caliper with an accuracy of 0.01 mm. During microstructure and surface wear observation, the surface morphology of concrete samples is scanned using a 3D scanner (SHINING 3D, EinScan Pro 2X). The concrete surfaces at wear times of 24 h, 48 h, 72 h and 96 h are recorded using a high-definition camera. The original worn surfaces are analyzed using image analysis software Image J to obtain pores and exposed aggregates on the worn surface. The microstructures of the worn concrete surface and worn fibers are analyzed using a scanning electron microscope (SEM) analyzer (Thermo Scientific, Apreo 2).

A first type of test investigates the influence of three different types of steel fibers, including copper-plated steel fibers, hooked-end steel fibers, and milled steel fibers, and different contents thereof, on the wear resistance of the matrix enhancement material 4.

The characteristics of the three different types of steel fibers are shown in Table 1.

TABLE 1
Characteristics of steel fibers

| | | | | | Tensile |
|---|---|---|---|---|---|
| Fiber | | Width | Length | Density | strength |
| code | Fiber type | (mm) | (mm) | (kg/m³) | (MPa) |
| S | Copper-plated steel fiber | 0.20 | 13 | 7850 | 2850 |
| M | Hooked-end steel fiber | 0.55 | 35 | 7850 | 1120 |
| L | Milled steel fiber | 2.10 | 38 | 7850 | 650 |

Multiple groups of samples are designed using a controlled variables approach where the type and dosage of steel fibers are varied while all other components are kept identical. Six representative sample groups are selected for explanation in combination with experimental results. The six sample groups are designated as R, S1, M1, L1, M0.5 and M1.5. The proportions of components for each sample are shown in Table 2.

TABLE 2
Proportions of components for representative
matrix enhancement material samples

| Sample | | Steel fiber | |
|---|---|---|---|
| code | Steel fiber type | dosage (Vol. %) | Other Components |
| Ref. 1 | None | 0 | Per cubic meter of matrix |
| S1 | Copper-plated steel fiber | 1 | enhancement material: 661 |
| M1 | Hooked-end steel fiber | 1 | kg of coarse aggregate, 450 |
| L1 | Milled steel fiber | 1 | kg of silicate cement, 50 kg |
| M0.5 | Hooked-end steel fiber | 0.5 | of microsilica fume, 640 kg |
| M1.5 | Hooked-end steel fiber | 1.5 | of ISO standard sand, 5 kg of |
| | | | water reducing agent, and |
| | | | 125 kg of water |

The sample designated as Ref. 1 is a fiber-free sample, serving as a reference group. Among samples designated as S1, M1, L1, M0.5, and M1.5, the letters indicate the fiber type, where “S” denotes copper-plated steel fiber, “M” denotes hooked-end steel fiber, and “L” denotes milled steel fiber; and the numbers indicate the dosage of steel fibers, specifically the volume fraction of steel fiber.

It should be noted that the 661 kg of coarse aggregate is formed by mixing 367 kg of aggregate with a particle size of 2.36-4.75 mm, 173 kg of aggregate with a particle size of 4.75-7 mm, and 121 kg of aggregate with a particle size of 7-9.5 mm.

Limestone is the most common gravel particle in the southwestern region of China. Therefore, gravel with a particle size of 13.2-20 mm and an average particle size of 16.6 mm is selected during the testing process to simulate solid particles in debris flow. The formulation of the debris flow abrasive material is shown in Table 3.

TABLE 3
Formulation of debris flow abrasive material

| Gravel | Slurry | Total volume | Gravel dosage | S/W | Slurry viscosity |
|---|---|---|---|---|---|
| (g) | (mL) | (mL) | (Vol. %) | Ratio | (mPa · s) |
| 2,120 | 3,200 | 4,000 | 20% | 1:1 | 756 |

2120 g of the gravel particles accounts for 20% of a total volume of debris flow material. The slurry is a mixture of water and soil with a soil-to water weight ratio (S/W) of 1:1.

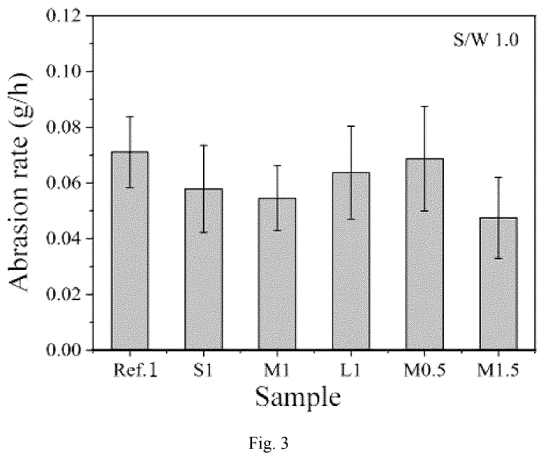

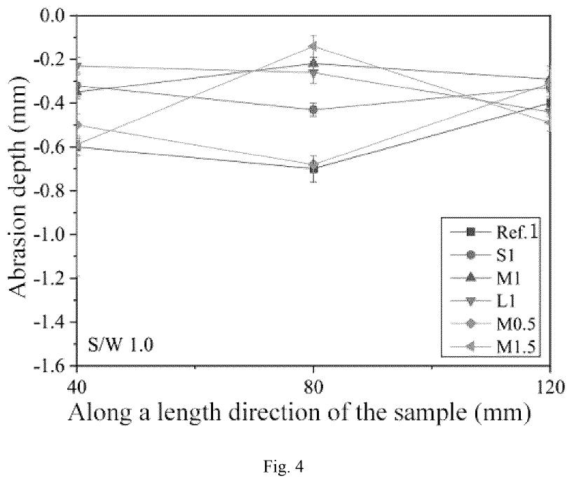

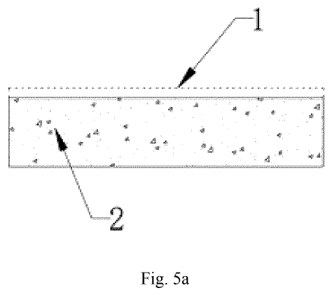

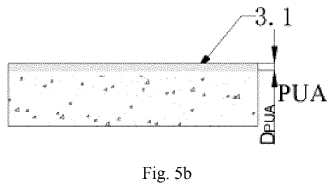

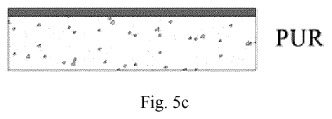

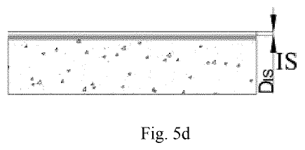

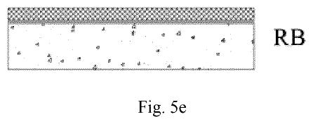

The results of the anti-abrasion performance test are shown in FIGS. 3 and 4. Comparing groups S1, M1 and L1, all with a steel fiber dosage of 1%, S1 (copper-plated steel fiber) and M1 (hooked-end steel fiber) exhibit lower abrasion rates and abrasion depths, indicating better wear resistance than L1 (milled steel fiber). Comparing groups M0.5, M1 and M1.5 with different dosages of hooked-end steel fibers, a higher content of hooked-end steel fibers in the sample results in a slower abrasion rate and smaller abrasion depth. Furthermore, the compressive strength, flexural strength, and tensile strength of the M1.5 concrete sample are 102.6 MPa, 19.28 MPa, and 9.56 MPa, respectively. Compared to the reference group, increases of 62.9%, 64.5%, and 84.2% are observed, respectively. Compared to compressive strength, tensile strength is considered a suitable indicator for evaluating the wear resistance of concrete. It can be seen that the matrix enhancement material 4 using hooked-end steel fibers exhibits better tensile strength, energy absorption capacity, and residual strength, which may help improve the concrete's resistance to collision and friction from coarse solid particles in debris flow.

In a second type of test, polyurea coating, polyurethane waterproof coating, iron sheet, and rubber are selected for surface treatment of the debris flow prevention structure. Four types of surface wear-resistant layers, including polyurea layer PUA, polyurethane layer PUR, rigid iron sheet layer IS, and flexible layer RB, as shown in FIGS. 5b-e. The influence of different surface wear-resistant materials 3 on the surface wear resistance of the concrete prevention structure is investigated.

It should be noted that in the second type of test, the polyurea layer PUA, polyurethane layer PUR, rigid iron sheet layer IS, and flexible layer RB are all flat-laid surface wear-resistant layers 3.1 covering the surface of the samples.

The characteristic parameters of the four different types of surface wear-resistant layers are shown in Table 4.

TABLE 4
Characteristic parameters of different types of surface wear-resistant layers

| Sample | Substrate | Surface layer | Bonding | Substrate | Total weight |
|---|---|---|---|---|---|
| code | height (mm) | thickness (mm) | thickness (mm) | weight (g) | of sample (g) |
| Ref. 2 | 40 | 0 | 0 | 627 | 627 |
| PUA | 36.9 | 3.1 | — | 546.1 | 573.9 |
| PUR | 37.1 | 2.9 | — | 562.2 | 585.9 |
| IS | 38.2 | 0.5 | 0.5 | 601.5 | 617.4 |
| RB | 37.3 | 2 | 0.7 | 553.8 | 587.8 |

The dimensions of all samples are 40 mm×40 mm×160 mm. The sample designated as Ref.2 has no surface wear-resistant layer and serves as the reference group, as shown in FIG. 5a. The overall height of all samples is 40 mm. The substrate height is the height of the concrete substrate itself, not including the thickness of the surface wear-resistant layer. The thickness of the surface wear-resistant layer is the height of the surface wear-resistant layer made of different materials. Therefore, the total height of sample Ref.2 equals the substrate height, while the total height of samples PUA, PUR, IS, and RB is the sum of the substrate height and the surface wear-resistant layer thickness. The total weight of the sample is the substrate weight (i.e., a weight of the concrete substrate) plus a weight of the surface wear-resistant layer.

Gravel with a particle size of 13.2-20 mm and an average particle size of 16.6 mm is still selected to simulate solid particles in debris flow. The formulation of the debris flow abrasive material is shown in Table 5.

TABLE 5
Formulation of debris flow abrasive material

| Gravel | Slurry | Total volume | Gravel dosage | S/W | Slurry viscosity |
|---|---|---|---|---|---|
| (g) | (mL) | (mL) | (Vol. %) | Ratio | (mPa · s) |
| 3,180 | 2,800 | 4,000 | 30 | 1:1 | 756 |

3180 g of the gravel particles accounts for 30% of the total volume of debris flow material. The slurry is a mixture of soil and water with a soil-to water weight ratio (S/W) of 1:1.

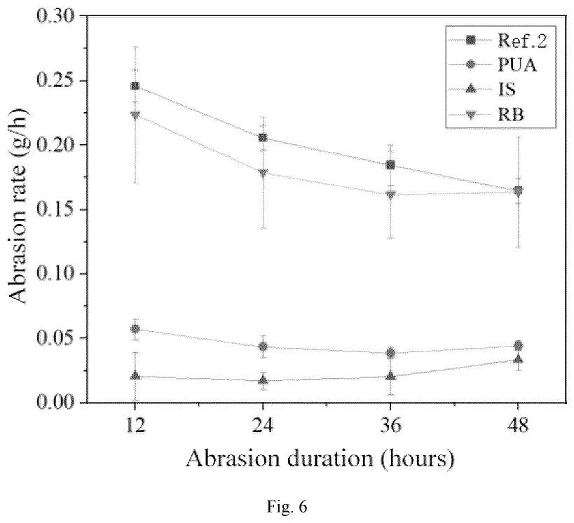

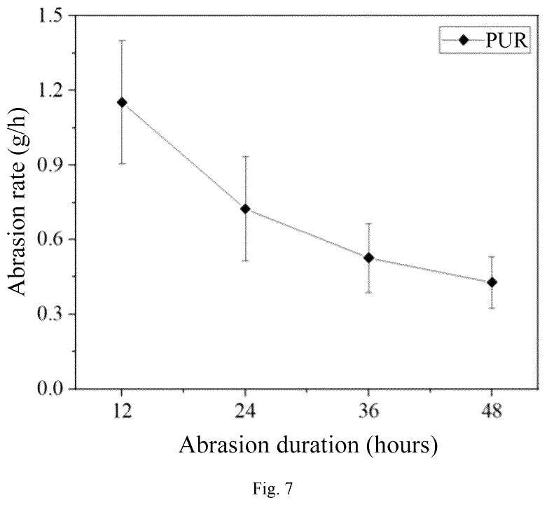

The results of the anti-abrasion performance test are shown in FIGS. 6 and 7. The polyurea layer PUA and the rigid iron sheet layer IS exhibit lower abrasion rates compared to the other two types.

In a third type of test, different styles of bionic structures 3.2 are designed on the substrate surface to investigate the influence of different bionic structures 3.2 on the wear resistance of the surface wear-resistant layer.

In this test, in order to accelerate abrasion testing efficiency and reduce testing time, the debris flow is set to have a flow velocity of 5 m/s, a volume content of particles (i.e., solid particles in debris flow, including stones and soil) of 30.3% and a density of 1.5 g/cm³. Compared to the gravel with an average particle size of 16.6 mm used in the first and second types of tests, 6 mm steel balls are used as the abrasive in the third type of test to simulate fixed particles in debris flow, further reducing the abrasion testing time, with a total testing time of 24 h.

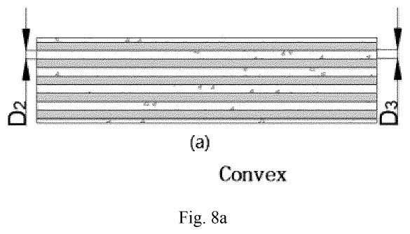

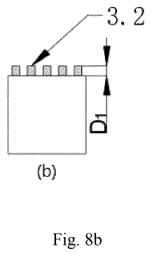

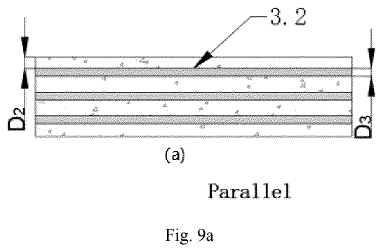

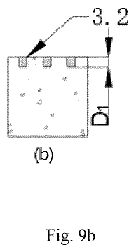

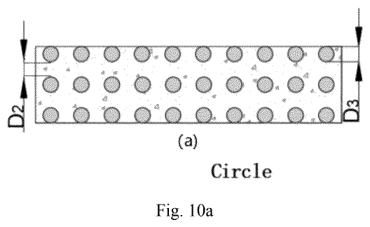

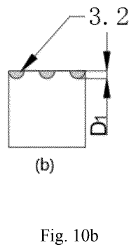

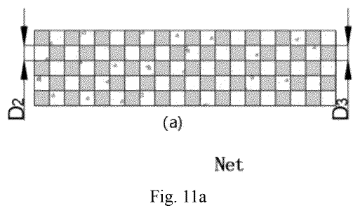

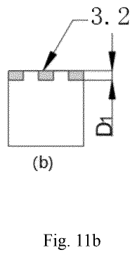

As shown in FIGS. 8a-b, 9a-b, 10a-b and 11a-b, a convex platform structure, a linear groove structure, a spherical groove structure and a grid groove structure are designed on the substrate surface, respectively. Referring to FIGS. 8a, 9a, 10a and 11a, viewed from a top perspective, the convex platform structure and linear groove structure form parallel stripe patterns on the substrate surface; the spherical groove structure forms a pattern composed of a matrix arrangement of multiple circular patterns; and the grid groove structure forms a pattern composed of a matrix arrangement of multiple square patterns. Referring to FIGS. 8b, 9b, 10b and 11b, viewed from a side perspective, the convex strips in the convex platform structure are raised above the substrate surface profile; the strip-shaped grooves of the linear groove structure, the hemispherical bodies of the spherical groove structure, and the square blocks of the grid groove structure are all embedded in the substrate with their top surfaces flush with the substrate surface, forming a smooth substrate surface profile. The height of the convex strip, the height of the strip-shaped groove, the height of the circular base of the hemispherical body, and the height of the square block are defined as the block height D₁. The distance between adjacent convex strips, adjacent strip-shaped grooves, adjacent hemispherical bodies, and adjacent square blocks is defined as the block spacing D₂. The width of the convex strip, the width of the strip-shaped groove, the diameter of the circular surface of the hemispherical body, and the width of the square block are defined as the block width D₃.

Firstly, in order to investigate the anti-abrasion capability of the convex platform structure, linear groove structure, spherical groove structure, and grid groove structure, Comparative test group 1 is designed. Four types of bionic structures 3.2, including convex platform, linear groove, spherical groove, and grid groove, are fabricated on the surface of 4 cm×4 cm×16 cm base samples according to the structural parameters of block height D1=5 mm, block spacing D2=8 mm, block width D3=8 mm, so as to form sample groups Convex, Parallel, Circle and Net. Sample Ref.3 without a surface wear-resistant layer serves as the reference group. The parameters of samples with different types of bionic structures 3.2 are shown in Table 6.

TABLE 6
Parameters of samples with different types of bionic structures

| | | | | | | Percentage |
|---|---|---|---|---|---|---|
| | | | | | | of the bionic |
| | Block | Block | Block | | Bionic | structure |
| | height | spacing | width | Substrate | structure | surface on |
| Sample | D₁ | D₂ | D₃ | area | area | the substrate |
| code | (mm) | (mm) | (mm) | (cm²) | (cm²) | surface (%) |
| Ref. 3 | 0 | 0 | 0 | 64 | 0 | 0 |
| Convex | 5 | 8 | 8 | 64 | 38.4 | 60 |
| Parallel | 5 | 8 | 8 | 64 | 38.4 | 60 |
| Circle | 5 | 8 | 8 | 64 | 15.1 | 23.6 |
| Net | 5 | 8 | 8 | 64 | 32.0 | 50 |

After setting bionic structures 3.2 with different morphologies according to the same structural parameters, the projected area of the polyurea layer in the top view differs, meaning the surface area of the bionic structure 3.2 differs, and the coverage ratio of the different bionic structures 3.2 on the substrate surface also differs.

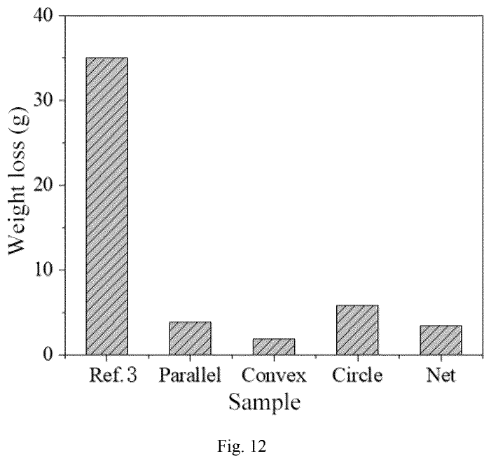

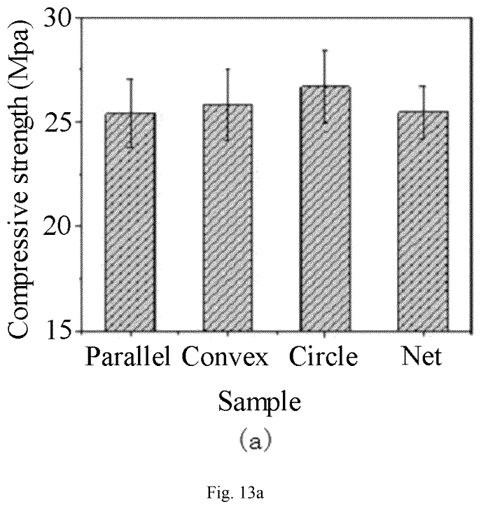

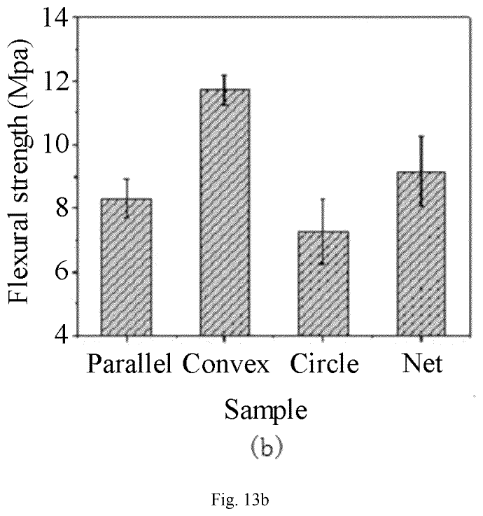

After 24 h of testing, the weight loss of samples Ref.3, Convex, Parallel, Circle, and Net in Table 6 is shown in FIG. 12. The weight loss of the sample without a surface wear-resistant layer is significantly higher than that of other samples with bionic structures 3.2. The weight loss of samples Convex, Parallel, and Net is similar and relatively low. Additionally, the compressive strength and flexural strength test results of samples Ref.3, Convex, Parallel, Circle, and Net in Table 6 are shown in FIGS. 13a-b. Comparative analysis of the compressive strength test results illustrated in FIG. 13a and the flexural strength test results illustrated in FIG. 13b shows that sample Convex exhibits superior overall performance in compressive strength and flexural strength.

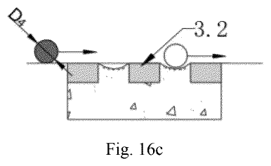

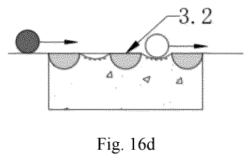

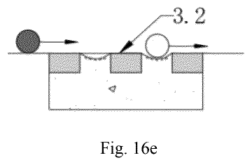

As shown in FIGS. 16a-e, schematic diagrams illustrate the principle of solid particles in debris flow scouring the surfaces of samples Ref.3, Convex, Parallel, Circle and Net. FIG. 16a corresponds to the abrasion principle on the surface of sample Ref.3. FIGS. 16b-e illustrate the surface abrasion principles for samples Convex, Parallel, Circle, and Net with bionic structures 3.2, respectively.

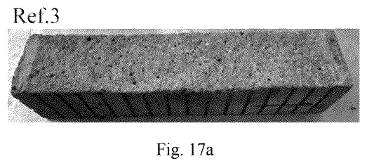

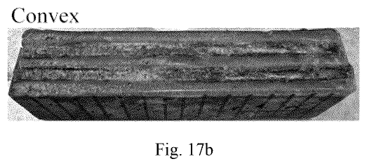

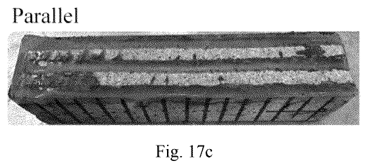

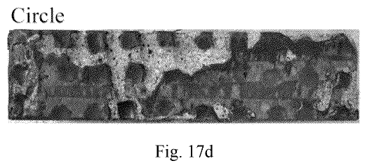

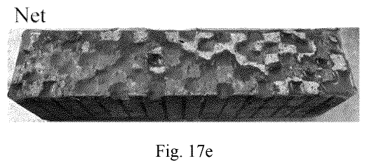

After 24 h of testing, the abrasion morphology of the five types of samples is shown in FIGS. 17a-e. FIGS. 17a-e display the abrasion morphology on the surfaces of samples Ref.3, Convex, Parallel, Circle, and Net, respectively, showing significant differences. Because the circular patterns in the spherical groove structure are arranged transversely with intervals, the uncovered substrate surface between two circular patterns is directly exposed to debris flow abrasion conditions and is prone to abrasion. Additionally, the bionic treatment area of the spherical groove structure is the smallest, at 15.1 cm², accounting for only 23.6% of the sample surface area. The bionic treatment areas of the convex platform structure, linear groove structure, and grid groove structure are 38.4 cm², 38.4 cm² and 32 cm², accounting for 60%, 60% and 50% of the total sample area, respectively. Therefore, after bionic treatment using convex platform, linear groove, and grid groove structures, the abrasion of the surface wear-resistant layer is less, and the wear resistance is better.

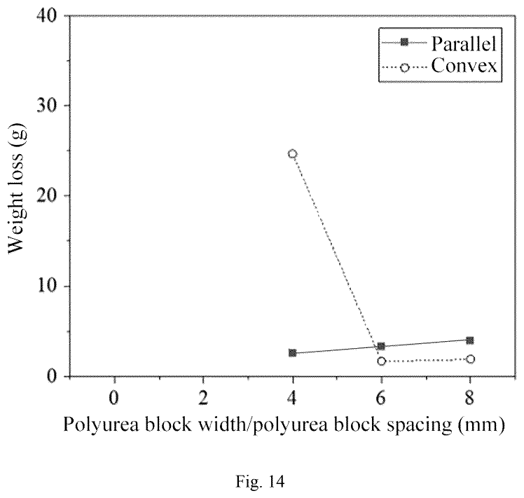

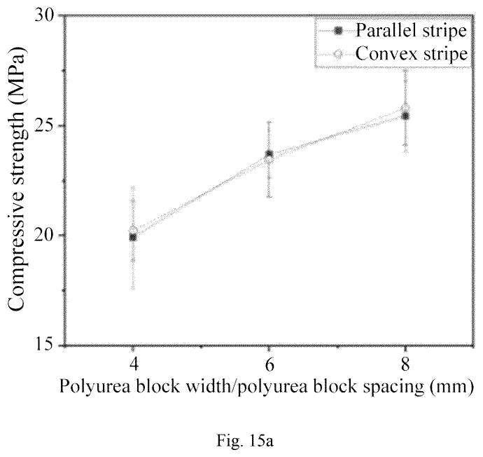

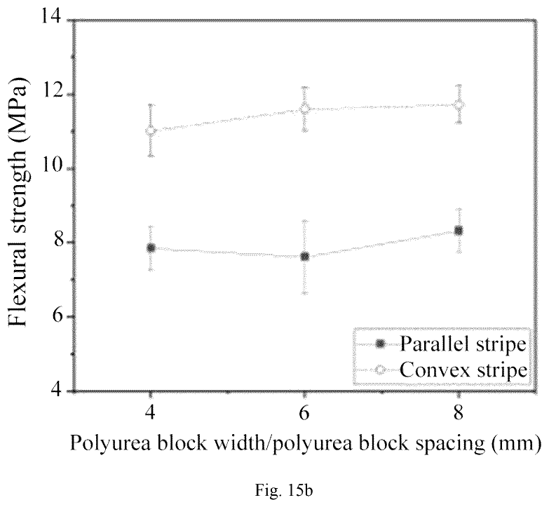

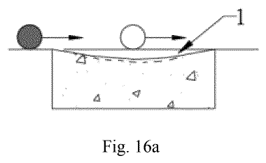

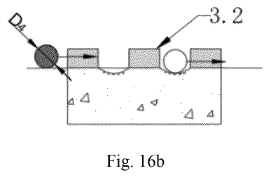

Secondly, in order to investigate whether the relationship between the size of the polyurea blocks in the four types of bionic structures 3.2 and the debris flow particle size D₄ affects the anti-abrasion capability, Comparative test group 2 is designed. Based on the precondition of an abrasive particle size of 6 mm, the block spacing D₂ and block width D₃ in the structural parameters of Convex and Parallel samples are designed as 4 mm, 6 mm and 8 mm, while other structural parameters remain the same. After 24 h of abrasion, the anti-abrasion performance test, compressive strength test and flexural strength test are performed. As shown in FIG. 14, samples with D2-D3-6 mm and D2=D3-8 mm exhibits a similar weight loss, which is significantly less than that of the sample with D2-D3-2 mm. As shown in FIGS. 15a-b, FIG. 15a illustrates the compressive strength test results, and FIG. 15b illustrates the flexural strength test results. Comparative analysis shows that when block spacing D₂ and block width D₃ are set to 4 mm, 6 mm and 8 mm, the compressive strength of Convex and Parallel samples is similar and shows an increasing trend. The flexural strength of Convex samples is significantly greater than that of Parallel samples and increases steadily; the flexural strength of Parallel samples first decreases and then increases.

Based on the design concepts of Comparative test groups 1 and 2, experiments are conducted by designing different combinations of structural parameter values using the controlled variables approach, leading to the following conclusions.

When bionic structures 3.2 differ only in morphology but have the same numerical structural parameter values, the surface wear-resistant layer using the convex platform structure as the bionic structure 3.2 exhibits excellent overall performance in wear resistance, compressive strength, and flexural strength.

When the block height D₁ and the average debris flow particle size D₄ in the bionic structure 3.2 satisfy D₁>D₄/1.2, the surface wear-resistant layer with this bionic structure 3.2 exhibits excellent overall performance in wear resistance, compressive strength, and flexural strength.

When the block spacing D₂ and block width D₃ in the bionic structure 3.2 satisfy D₂≤2D₃, the surface wear-resistant layer with this bionic structure 3.2 exhibits excellent overall performance in wear resistance, compressive strength, and flexural strength.

When the block spacing D₂ and the average debris flow particle size D₄ in the bionic structure 3.2 satisfy D₂>D₄, the surface wear-resistant layer with this bionic structure 3.2 exhibits excellent overall performance in wear resistance, compressive strength, and flexural strength.

Other parts of Embodiment 3 are identical to Embodiment 1 and thus are not reiterated.

The embodiments described above are merely illustrative of the present application, and are not intended to limit the scope of the present application. It should be understood that various modifications, replacements and improvements made by those of ordinary skill in the art without departing from the spirit of this application shall fall within the scope of the disclosure defined by the appended claims.

What is claimed is:

1. A method for reinforcing and repairing a debris flow prevention structure, comprising:
(1) evaluating a surface abrasion depth of the debris flow prevention structure to formulate a reinforcement and repair strategy;
(2) during implementation of a repair project, cleaning a to-be-constructed area according to the reinforcement and repair strategy, and pouring a matrix enhancement material into the to-be-constructed area so that the matrix enhancement material permeates into a substrate of the debris flow prevention structure for repairing or enhancing an ability to resist overall structural damage; and
(3) arranging a surface wear-resistant layer on a surface of the substrate to repair or enhance an ability to resist surface damage;
wherein step (3) is performed through steps of:
during construction, curing a polyurea material on the surface of the substrate to form the surface wear-resistant layer, such that a plurality of polyurea blocks are fixed on the surface of the substrate in a bionic arrangement to form a bionic structure;
the bionic structure is a convex platform structure, a linear groove structure, a spherical groove structure or a grid groove structure;
the convex platform structure is composed of a plurality of convex strips that are raised relative to a surface profile of the substrate and arranged in parallel, and a length direction of the plurality of convex strips is perpendicular to a flow direction of a debris flow;
the linear groove structure is composed of a plurality of strip-shaped grooves that are recessed relative to the surface profile of the substrate and arranged in parallel, and a length direction of the plurality of strip-shaped grooves is perpendicular to the flow direction of the debris flow;
the spherical groove structure is formed by a plurality of hemispherical bodies that are recessed relative to the surface profile of the substrate and arranged in a matrix pattern; and
the grid groove structure is formed by a plurality of square blocks that are recessed relative to the surface profile of the substrate and arranged in a matrix pattern.

2. The method of claim 1, wherein the plurality of convex strips, the plurality of strip-shaped grooves, the plurality of hemispherical bodies and the plurality of square blocks are the plurality of polyurea blocks formed by means of compression molding.

3. The method of claim 1, further comprising:
reserving a recess structure on the surface of the substrate according to a structure and arrangement of the plurality of polyurea blocks, and embedding the plurality of polyurea blocks in the recess structure.

4. The method of claim 1, wherein the matrix enhancement material comprises a coarse aggregate and a mortar; a gradation distribution of the coarse aggregate conforms to an Andreasen & Andersen model with a value of a distribution modulus q of 0.19; and the mortar is composed of a P·I-type 42.5-grade silicate cement, a microsilica fume, a sand, a steel fiber, a water reducing agent and water.

5. The method of claim 4, wherein the steel fiber is a copper-plated steel fiber or a hooked-end steel fiber, and a dosage of the steel fiber is 1% of a total volume of the matrix enhancement material.

6. A repair material for a debris flow prevention structure, applied to the method of claim 1 and comprising:
a matrix enhancement material; and
a surface wear-resistant layer;
wherein the matrix enhancement material is permeatable into a substrate of the debris flow prevention structure, and is configured to enhance resistance and reduce an overall structural damage caused by debris flow impact and environmental factors; and
the surface wear-resistant layer is capable of covering a surface of the debris flow prevention structure, and is configured to enhance resistance and reduce a surface damage caused by particle scouring in a debris flow.

7. A method for predicting an abrasion depth of a debris flow prevention structure that is adapted to implement the method of claim 1, comprising:
estimating the abrasion depth according to the following equation:
$${E}_{h} = \frac{a \times k \times t}{{ρ}_{c}} ,$$
wherein Eₕ is the abrasion depth, unit: m; k is an abrasion coefficient representing a abrasion weight loss per unit area per unit time, unit: kg/h/m²; ρ_{c} represents a structural density of the debris flow prevention structure, unit: kg/m³; t represents a duration of the debris flow, unit: h; and a represents a correction coefficient.

8. The method of claim 7, wherein the correction coefficient is configured to adjust a difference between indoor abrasive parameters and actual debris flow parameters during an abrasion coefficient test; a value of the correction coefficient α is calculated through the following equation:
$$a = ( \frac{{V}_{s}}{{V}_{0}} ) \times ( \frac{{ρ}_{s}}{{ρ}_{0}} ) \times {( \frac{{D}_{s}}{{D}_{0}} )}^{2} \times {( \frac{{u}_{s}}{{u}_{0}} )}^{2} ,$$
wherein Vₛ represents a volume content of a solid phase particles of the debris flow, unit: %; ρₛ represents a density of the solid phase particles of the debris flow, unit: kg/m³; Dₛ represents a particle size of the solid phase particles of the debris flow, unit: m; μₛ represents a flow velocity of the solid phase particles of the debris flow, unit: m/s; V₀ represents a volume content of solid phase particles of an abrasive, unit: %; ρ₀ represents a density of the solid phase particles of the abrasive, unit: kg/m³; D₀ represents a particle size of the solid phase particles of the abrasive, unit: m; and μ₀ represents a flow velocity of the solid phase particles of the abrasive, unit: m/s.
